(19) United States
(12) Patent Application Publication
(10) Pub. No.: US 2025/0146548 A1
(43) Pub. Date: May 8, 2025

(54) Electromagnetically Actuated Spring-Applied Brake And Method For Its Manufacture

(71) Applicant: KEB Automation KG, Barntrup (DE)

(72) Inventors: Helmut WILLER, Detmold (DE); Jannis-Martin SCHWEDT, Barntrup (DE)

(21) Appl. No.: 18/933,081

(22) Filed: Oct. 31, 2024

(30) Foreign Application Priority Data
Nov. 2, 2023 (EP) 23207523.4

(51) Int. Cl. F16D 65/18; F16D 55/227; F16D 59/00; F16D 121/22

(52) U.S. Cl. CPC F16D 65/186; F16D 55/227; F16D 59/00; F16D 2121/22; F16D 2250/0084

(57) ABSTRACT

An electromagnetically actuated spring-applied brake comprises a brake disk which can be arranged on a shaft in a non-rotatable but axially displaceable manner, an electromagnet which has a magnet housing and a coil accommodated therein, an armature plate arranged to be displaceable axially between the brake disk and the magnet housing and a flange, which is arranged non-rotatably on the magnet housing by a connecting element. The brake disk and the armature plate are arranged between the flange and the magnet housing. The connecting element engages in a counterpart which is designed to correspond to the connecting element and is pressed into a blind hole provided by the magnet housing. The edge of the counterpart facing the magnet housing is arranged at a distance from the bottom of the blind hole while leaving a gap space having a residual volume.

### CROSS-REFERENCE TO RELATED APPLICATION

This application claims the benefit and priority of European Patent Application No. 23207523.4, filed Nov. 2, 2023. The entire disclosure of the above application is incorporated herein by reference.

### FIELD

The disclosure relates to an electromagnetically actuated spring-applied brake comprising a brake disk that can be arranged on a shaft in a rotationally fixed but axially displaceable manner, an electromagnet which has a magnet housing and a coil accommodated therein, an armature plate which is arranged between the brake disk and the magnet housing in an axially displaceable manner, and a flange which is arranged on the magnet housing in a rotationally fixed manner by means of a connecting element, the brake disk and the armature plate being arranged between the flange and the magnet housing. The disclosure also relates to a method of manufacturing an electromagnetically actuated spring-applied brake.

### BACKGROUND

Electromagnetically actuated spring-applied brakes are known per se from prior art. Accordingly, there is no need for separate proof in printed form. Reference is therefore made only by way of example to EP 4 184 032 A1 which discloses a generic spring-applied brake.

In the case of spring-applied brakes of the generic type, the aim is per se to be able to precisely form and/or set the axial distance between the armature plate on the one hand and the magnet housing on the other hand, namely the so-called air gap, for further optimized use of the spring-applied brake. A fundamental problem here is that the individual components of the spring-applied brake, in particular the flange, the brake disk and the armature plate, have tolerances with regard to their respective geometric dimensions due to the manufacturing process, which tolerances can add up unfavorably with regard to the air gap between the magnet housing and the armature plate in the final assembled state. If the air gap is too large or also too small, this can have the disadvantage that the spring-applied brake cannot be operated as intended.

In order to address this problem, it is known from prior art to use plastically deformable spacer bushings for the spaced arrangement of the flange and the magnet housing. Such a design is disclosed for example in DE 10 2013 219 878 B3.

The spacer bushings provided according to DE 10 2013 219 878 B3 each have a section which allows plastic deformation. During the assembly of a spring-applied brake, plastic deformation of the spacer bushings occurs due to shortening as a result of setting a desired air gap. This shortening is monitored by means of a displacement sensor, which is intended to prevent excessive shortening of the spacer bushings and the associated creation of an air gap which is dimensioned too small. A particular drawback of this design is the equipment needed for proper assembly or the complex assembly as such, as it is time-consuming and therefore expensive.

It is also known from prior art, for example according to EP 3 947 062 B1, to pre-assemble a spring-applied brake with the aid of temporarily used spacers, such as gauges. The temporarily used spacers ensure the creation of a desired air gap. In this pre-assembled position, the flange and the magnet housing are welded together to ensure that the flange is permanently aligned with the magnet housing. The temporary spacers can then be removed again and the spring-applied brake produced in this way is then ready for use as intended. A particular disadvantage of this design is the amount of equipment needed for proper assembly. Another disadvantage is the lacking ability to disassemble the brake at a later time, in particular for repair purposes. Welding the flange and the magnet housing is also comparatively complex and requires the provision of appropriate welding equipment.

Based on the prior art described above, the object of the disclosure is to propose a spring-applied brake of the type mentioned at the beginning, the design of which has been further developed in such a way that an optimized setting of a desired air gap is possible while providing for easy assembly. Furthermore, a method for manufacturing such a spring-applied brake is to be proposed.

### SUMMARY

On the device side, in order to a achieve this object, a spring-applied brake of the type mentioned at the beginning is proposed which is characterized by the fact that the connecting element engages in a counterpart which is designed to correspond to the connecting element and is pressed into a blind hole provided by the magnet housing, the edge of the counterpart facing the magnet housing being arranged at a distance from the bottom of the blind hole, leaving a gap space with a residual volume.

On the method side, there is proposed as a solution a method for producing an electromagnetically actuated spring-applied brake of the type according to the disclosure, characterized in that the magnet housing is fixed in a holding device, in that the brake disk is arranged on the magnet housing with the armature plate interposed and in that the counterpart is pressed into the blind hole by means of a press plunger, wherein the press plunger cooperates with a first section with the counterpart and with a second section with the brake disk, wherein the second section protrudes on the side of the magnet housing axially beyond the first section and wherein the press plunger is displaced towards the magnet housing until the armature plate strikes against the magnet housing.

A connecting element is used to arrange the flange on the magnet housing. In the final assembled state, this connecting element engages in a counterpart provided by the magnet housing. The counterpart is pressed into a blind hole provided by the magnet housing. In the final assembled state, the connecting element is thus supported on the solenoid housing with the counterpart interposed.

The connection between the connecting element and the counterpart in the final assembled state is preferably detachable. It is therefore preferable that the connecting element has a thread. The counterpart is designed to correspond to the connecting element and therefore has a threaded mating contour in this case or is equipped with a corresponding mating contour in the case of initial assembly. A screw is preferably used as the thread-carrying connecting element, in particular a self-furrowing or self-tapping screw. The thread provided by the counterpart in the final assembled state is therefore formed when a self-furrowing or self-tapping screw is used at the moment of the initial assembly.

In the case of a connecting element equipped with a thread, the counterpart is preferably designed as a sleeve or bushing. In the final assembled state, this is pressed into the associated blind hole and provides with its inner surface the thread which is formed corresponding to the connecting element.

An alternative to a non-detachable connection between the connecting element and the counterpart is a non-detachable connection which can, for example, be designed to be material-locking or quasi-material-locking. A non-detachable positive connection is also conceivable.

In any case, however, the detachable connection of the connecting element and counterpart is preferred with the embodiment according to the disclosure because, on the one hand, this reduces the amount of equipment required for initial assembly and, in addition, makes it possible to carry out disassembly in a simple manner and, in particular, in a non-destructive manner, especially in the event of repairs.

For a proper arrangement of the flange on the magnet housing, a large number of connecting elements are preferably provided, each of which is in operative connection with the magnet housing in the final assembled state. The connecting elements are preferably evenly distributed in the circumferential direction of the spring-applied brake.

One threaded sleeve per connecting element is provided for the arrangement of a connecting element on the magnet housing. The associated connecting element engages in this threaded sleeve in the final assembled state, and does so detachably. This makes disassembly possible in an advantageous manner, particularly in the event of repairs.

Each threaded sleeve is pressed into a blind hole provided by the magnet housing. A force-locking and/or form-locking connection is thus formed between the threaded sleeve and the blind hole provided by the magnet housing.

According to the disclosure, it is further provided that the edge of the threaded sleeve facing the magnet housing is arranged at a distance from the bottom of the blind hole in the final assembled state, leaving a gap space having a residual volume. The threaded sleeve is therefore not in contact with the bottom of the blind hole in the final assembled state, unlike the design according to DE 10 2013 219 878 B3, for example.

The provision of a gap space by the design makes it advantageously possible to adjust the penetration depth of the threaded sleeve into the associated blind hole as a function of the actual component tolerances. Tolerance compensation can thus be advantageously achieved by pressing the threaded sleeve correspondingly far into the blind hole, resulting in an optimized air gap design.

In the design according to DE 10 2013 219 878 B3, the spacer bushing described there rests on the bottom of the associated blind hole in the final assembled state, with its edge facing the magnet housing. The reason for this is that an abutment is provided for plastic deformation of the spacer bushing. In contrast to this, the disclosure proposes a threaded sleeve which is not shortened in length in order to set the optimized air gap, but which is inserted sufficiently deep into the associated blind hole in the axial direction corresponding to the desirable air gap to be achieved. In order to be able to guarantee this reliably, the disclosure proposes a blind hole with a depth which, in the axial direction, has a dimension which exceeds the part of the threaded sleeve accommodated by the blind hole in the final assembled state, whereby, in the final assembled state, a gap space remains between the edge of the threaded sleeve facing the magnet housing and the bottom of the blind hole which defines a residual volume. The longitudinal extent of the blind hole therefore exceeds the penetration depth of the section of the threaded sleeve located in the blind hole.

On the method side, a press plunger is used to press the threaded sleeve into the associated blind hole. This press plunger has two sections, namely a first section that interacts with the threaded sleeve and a second section that interacts with the brake disk. The second section protrudes axially beyond the first section on the magnetic housing side. This axial spacing between the first section and the second section corresponds to the air gap formed in the final assembled state as intended.

During assembly, the press plunger is moved in the direction of the magnet housing until the armature plate strikes against the magnet housing. Due to the axial offset between the first section and the second section, this automatically results in a protrusion of the threaded sleeve away from the magnet housing in relation to the upper end edge of the brake disk. In the final assembled state, the flange of the spring-applied brake rests on the threaded sleeve, resulting in a distance between the surface of the flange on the magnet housing side on the one hand and the magnet housing on the other, which corresponds to the thickness of the brake disk and armature plate on the one hand and the axial protrusion of the first and second sections on the other. The axial protrusion represents the desirable air gap to be achieved. This is because in the final assembled state, the compression spring elements press against the armature plate on the magnet housing side and thus against the brake disk arranged above it in the vertical direction, which in turn is supported on the flange. As a result, an air gap is formed between the armature plate and the magnet housing, the geometric dimensions of which correspond to the axial distance between the first and second sections of the press plunger in the vertical direction.

The design according to the disclosure proves to be advantageous overall, as it enables simplified assembly while at the same time ensuring an optimized air gap.

The air gap setting is independent of any component tolerances, making it simple and reproducible. The air gap formed in the final assembled state results from the axial offset of the sections provided by the press plunger, i.e. the first section which interacts with the threaded sleeve and the second section which interacts with the brake disk. During assembly, this axial offset ensures that the flange is positioned in relation to the magnet housing in such a way that a gap distance is formed between the flange and the magnet housing which corresponds to the thickness of the armature plate and brake disk on the one hand and the desired air gap dimensions on the other. On the method side, the press plunger can be moved to the stop of the armature plate on the magnet housing, i.e. to “zero”. In this respect, no special force or displacement measurement is required during assembly.

Instead, the press plunger can be moved until the armature plate strikes against the magnet housing, while at the same time the desired gap dimension for the air gap is ensured due to the design. The design according to the disclosure also permits disassembly, particularly in the event of repair, since the connecting element provided for fixing the flange plate in position on the magnet housing is a threaded connecting element, preferably a screw, which engages releasably in the associated threaded sleeve.

In the final assembled state, the threaded sleeve is pressed into the blind hole provided by the magnet housing. The connecting element engages in the threaded sleeve in the form of a threaded connection, which altogether ensures that the flange is securely fixed in the correct position in relation to the magnet housing. In order to create additional safety and also to ensure that a pressed threaded sleeve does not tear out with regard to dynamically occurring force loads, it is preferable to screw a connecting element not only to the threaded sleeve, but also to the magnet housing as such. In accordance with a further feature of the disclosure, it is therefore provided that a bore adjoins the blind hole in an axial extension of the blind hole, into which bore the connecting element detachably engages. In the final assembled state, the connecting element thus engages both in the threaded sleeve and in the bore that adjoins the blind hole in an axial extension of the latter. In the final assembled state, the connecting element is thus in indirect connection with the magnet housing via the threaded sleeve on the one hand and in direct connection with the magnet housing via the bore which adjoins the blind hole in axial extension on the other hand.

According to a further feature of the disclosure, the bore has a smaller internal diameter than the internal diameter of the blind hole. This takes account of the fact that the threaded sleeve is pressed into the blind hole in the final assembled state. In this respect, the bore and the threaded sleeve are matched to each other in terms of their respective internal diameters.

According to a further feature of the disclosure, it is provided that the connecting element is a thread-furrowing or thread-cutting screw. During assembly, the screw is screwed into the threaded sleeve as well as into the bore adjoining the blind hole in the axial direction, whereby as a result of this screwing, a thread configuration is formed with regard to both the threaded sleeve and the bore by self-furrowing or self-tapping.

The use of a thread-furrowing or thread-cutting screw has the advantage that when a screw is screwed into the bore adjacent to the blind hole in the axial direction, there is no axial offset between the threaded sleeve and the blind hole due to a displacement of the threaded sleeve. In addition, the self-furrowing or self-tapping screw results in a thread design that bridges the gap between the lower edge of the threaded sleeve and the bottom of the blind hole between the threaded sleeve and the hole adjacent to the blind hole. This makes it possible, as described above, to position the threaded sleeve in relation to the blind hole depending on the desired air gap without changing the relative position of the threaded sleeve in relation to the blind hole or the bore when the screw is subsequently screwed into the bore provided in the extension of the blind hole.

Screwing the thread-furrowing or thread-cutting screw to both the threaded sleeve and the magnet housing has the advantage that the preload between the threaded sleeve and the screw is initially built up during screwing, which cannot lead to a relative movement of the threaded sleeve compared to the magnet housing. As soon as the screw is inserted into the threaded sleeve and the bore in the magnet housing is reached, no further preload is built up between the magnet housing and the screw. This continues to exist between the threaded sleeve and the screw so that, as a consequence, screwing the screw also into the housing, i.e. the housing-side bore, cannot lead to any relative movement of the threaded sleeve and the housing.

In order to secure the position and fix the flange in relation to the magnet housing as intended, it is not necessary to provide furrows or cut threads along the entire length of the threaded sleeve. Instead, only a screw engagement takes place in a lower section of the threaded sleeve facing the magnet housing. According to a further feature of the disclosure, it is therefore provided that the threaded sleeve has a region on the inside which interacts with the thread-furrowing or thread-cutting screw and which extends in the axial direction over a partial section of the threaded sleeve. This simplifies assembly, but at the same time ensures a secure arrangement of the flange on the magnet housing in the final assembled state.

The pressing between the threaded sleeve and the magnet housing also does not need to take place over the entire length of the threaded sleeve. Instead, only a section facing the blind hole can be provided which is smooth or roughened, in particular knurled. According to a further feature of the disclosure, it is therefore provided that the threaded sleeve has a roughened, in particular knurled, region on the outside of its outer surface which extends in the axial direction over a partial section of the threaded sleeve. In the final assembled state, the threaded sleeve is in operative connection with the magnet housing via this part by pressing, whereby a positive and non-positive connection is provided due to the roughened design of the outer surface of the threaded sleeve. Alternatively, or in combination with such a region, a region can also be provided which is stepped in the radial direction of the threaded sleeve, i.e. a region that protrudes radially from the lateral surface provided by the threaded sleeve on the outside. A region is therefore proposed which is radially stepped and/or roughened.

In accordance with a further feature of the disclosure, it is further proposed on the method side that the armature plate is arranged on the magnet housing with intermediate arrangement of compression spring elements. During assembly, these compression spring elements are compressed by the press plunger until the armature plate is in contact with the magnet housing, i.e. until it strikes against the magnet housing as a result of the force applied by the press plunger. As soon as this position of the armature plate is reached, the pressing-in process of the threaded sleeve is completed, whereby the design of the press plunger already described above ensures that the threaded sleeve is pressed into the associated blind hole to such a depth that a desired air gap is created between the armature plate and the magnet housing in the final assembled state. This air gap is created by the fact that, in the final assembled state, the compression spring elements arranged between the armature plate and the magnet housing urge the armature plate away from the magnet housing, thereby forming the desired air gap between the armature plate and the magnet housing.

According to a further feature of the disclosure, it is provided in this context that the axial offset between the first section and the second section of the press plunger is selected in accordance with a desired air gap between the armature plate and the magnet housing in the final assembled state. It is therefore proposed to provide corresponding press plungers depending on the desired air gap. These press plungers can be used independently of any component tolerance, whereby it is ensured in any case that, depending on the selected press plunger, i.e. the selected axial offset between the first section and the second section of a respective press plunger, a corresponding air gap configuration is achieved as a result.

According to a further feature of the disclosure, it is provided that the flange is screwed to the magnet housing with the interposition of the brake disk, the armature plate and the compression spring elements, with a thread-cutting or thread-furrowing screw being used as the connecting element which is inserted into the threaded sleeve.

After the threaded sleeve has been pressed into the associated blind hole as intended, the press plunger is removed and the flange is placed on the brake disk after the magnet housing has been removed. The distance between the flange and the magnet housing is determined by the section of the threaded sleeve protruding from the blind hole in the magnet housing. This section defines the distance between the flange and the magnet housing. This distance corresponds to the thickness of the brake disk and armature plate on the one hand and the desired air gap design on the other, which results from the axial offset of the first section and second section of the press plunger. In this way, easy assembly can be achieved in the simplest possible way, while at the same time ensuring the desired air gap configuration, regardless of any component tolerances. Furthermore, no spacers, in particular no gauges, as required in the prior art, are required for proper assembly.

### BRIEF DESCRIPTION OF THE DRAWINGS

Further features and advantages of the disclosure become apparent from the following description with reference to the drawing Figures.

FIG. 1 shows a schematic exploded view of a spring-applied brake according to the disclosure;

FIG. 2 shows a sectional side view of a first assembly step for manufacturing the spring-applied brake according to FIG. 1;

FIG. 3 shows a sectional side view of a second assembly step for manufacturing the spring-applied brake according to FIG. 1;

FIG. 4 shows a sectional side view of a finally assembled spring-applied brake according to the disclosure; and

FIG. 5 is a schematic diagram showing the application force of a spring-applied brake according to the disclosure.

### DETAILED DESCRIPTION

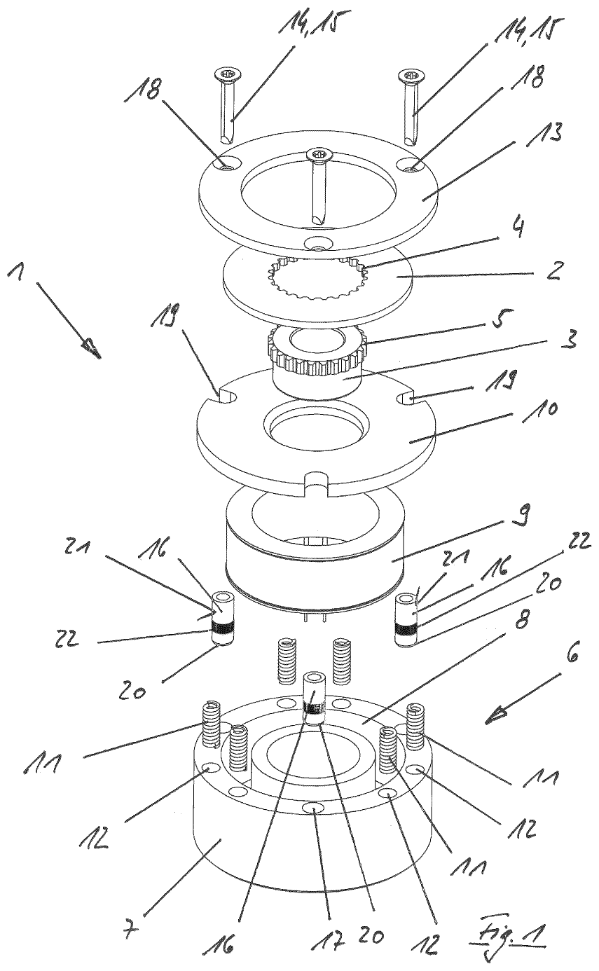

FIG. 1 shows a schematic exploded view of a spring-applied brake 1 according to the disclosure. This is designed to be electromagnetically actuated and has an electromagnet 6, a brake disk 2 and a flange 13.

In the final assembled state, the brake disk 2 is fixed against rotation on a shaft not shown in detail in the Figures, for example the output shaft of an electric motor, but is nevertheless axially displaceable in the longitudinal direction of the shaft. For this purpose, a shaft-hub connection can be provided in a manner known per se, whereby the brake disk 2 provides a toothed contour 4 which, in the final assembled state, is in operative connection with the mating contour 5 of a hub 3 arranged on a shaft.

The electromagnet 6 has a magnet housing 7, which accommodates a coil 9 in the final assembled state. For this purpose, the magnet housing 7 has an annulus 8 that corresponds to the geometric design of the coil 9 and accommodates it in the final assembled state.

The spring-applied brake 1 also has an armature plate 10 which is axially displaceable between the brake disk 2 and the magnet housing 7. This axially displaceable arrangement of the armature plate 10 takes place with an intermediate arrangement of compression spring elements 11. These are arranged in bores 12 provided by the magnet housing 7 and press against the armature plate 10 from below in the height direction in the fully assembled state. The compression spring elements 11 therefore act on the armature plate 10 via the side of the armature plate 10 facing away from the brake disc 2.

The armature plate 10 is positioned in a non-rotatable manner relative to the magnet housing 7, which is achieved by positive locking in that the armature plate 10 has recesses 19 which, in the final assembled state, interact with sleeves described in more detail below, which serve as threaded sleeves 16 for the positionally fixed and secure arrangement of the flange 13 on the magnet housing 7.

As a result of the design described above, the armature plate 10 is non-rotatable in the final assembled state, but is nevertheless arranged on the magnet housing 7 so that it can be axially displaced relative to the magnet housing 7 with the intermediate arrangement of the compression spring elements 11.

The spring-applied brake 1 also has the aforementioned flange 13 which is connected to the magnet housing 7 in a non-rotatable manner, for which purpose threaded connecting elements 14 are provided in the form of screws 15 which are passed through bores 18 on the flange side and engage releasably in threaded sleeves 16 on the magnet housing side in the fully assembled state. The brake disk 2 and the armature plate 10 are arranged between the flange 13 and the magnet housing 7.

When the coil 9 is energized, the magnet housing 7 of the electromagnet 6 is magnetized, which leads to the armature plate 10 being attracted by the magnet housing 7. This creates a gap between the flange 13 and armature plate 10 that exceeds the thickness of the brake disk 2, so that the brake disk 2 can rotate freely between the flange 13 and armature plate 10. This allows the shaft carrying the brake disk 2, for example of an electric motor, to rotate.

As soon as a power supply to the coil 9 is switched off or fails, the armature plate 10 is not magnetically attracted by the electromagnet 6, so that the armature plate 10, induced by the compression spring elements 14, is moved upwards with reference to the drawing plane according to FIG. 1 by the compression spring elements 14 and pressed against the flange 13, with the brake disk 2 interposed. As a result, a frictional connection occurs, in particular between the armature plate 10 and the brake disk 2, but also between the brake disk 2 and the flange 13. This frictional connection ensures that the brake disk 2 is fixed, with the result that a rotational movement of the brake disk 2 is no longer possible and thus also a rotational movement of the shaft carrying the brake disk 2, for example the shaft of an electric motor, is not possible. The electric motor is therefore braked by the fixing of the brake disk 2.

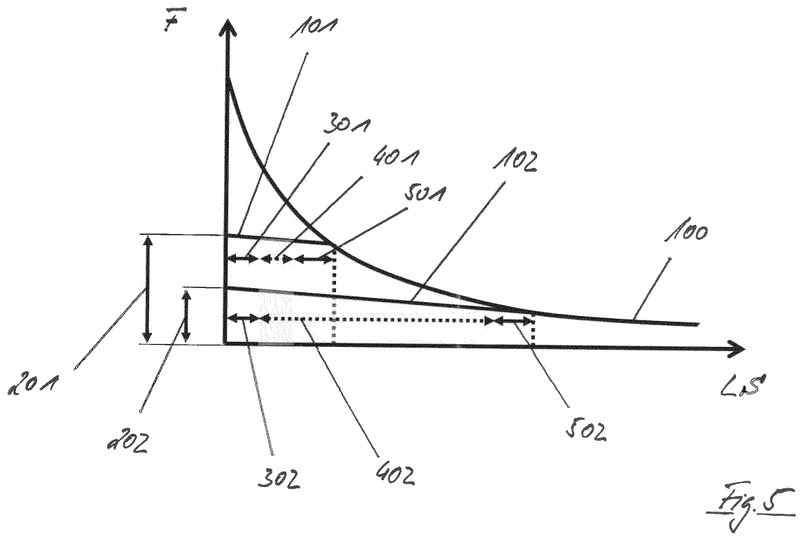

The gap which forms between the flange 13 and the armature plate 10 when the coil 9 is energized and which exceeds the thickness of the brake disk 2 depends on the air gap that forms between the armature plate 10 and the magnet housing 7 in the final assembled state, as shown in FIG. 4.

In the final assembled state and when the coil 9 is not energized, the compression spring elements 11 press against the armature plate 10 from below in the height direction as shown in FIG. 4, and the armature plate in turn presses against the flange 13 fixed relative to the magnet housing 7, with the brake disc 2 interposed. As a result, there is an air gap between the armature plate 10 and the magnet housing 7 which has the gap dimension X, as shown in FIG. 4. In order to be able to set this air gap in an optimized manner, threaded sleeves 16 according to the design of the disclosure are used which are pressed into the corresponding blind holes 17 of the magnet housing 7 corresponding to the desired air gap configuration, as can be seen in particular from a combined view of FIGS. 1 to 3.

As can initially be seen from the illustration in FIG. 1, three screws 15 are used for the precise and secure positioning of the flange 13 on the magnet housing 7. Accordingly, three threaded sleeves 16 are also provided, each of which is releasably engaged by a screw 15 in the final assembled state.

For the arrangement of the threaded sleeves 16 on the magnet housing, one blind hole 17, which is provided by the magnet housing 7, is provided per threaded sleeve 16. In the final assembled state, a threaded sleeve 16 is pressed into the associated blind hole 17. Each threaded sleeve 16 has a region 22 on its outer surface 21 that is roughened, in particular knurled. This ensures an improved press fit of a threaded sleeve 16 within an associated blind hole 17.

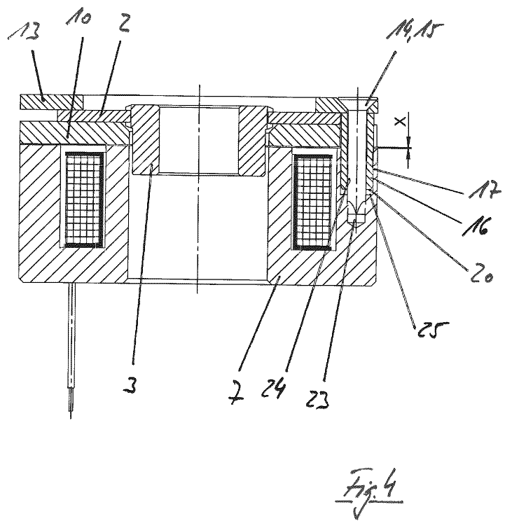

As can be seen in particular from the illustration according to FIG. 3, in the final assembled state of a threaded sleeve 16, the edge 20 of the threaded sleeve 16 facing the magnet housing 7 is arranged at a distance from the bottom 26 of the blind hole 17, leaving a gap space 25 having a residual volume. A blind hole 17 is therefore longer in the direction of the arrow 32, i.e. in the axial direction, than the part of the threaded sleeve 16 received by the blind hole 17 in the final assembled state. The later dimension of the air gap between the armature plate 10 and the magnet housing 7 can thus be formed in a simple manner via the press-fit depth of the threaded sleeve 16 in the associated blind hole 17.

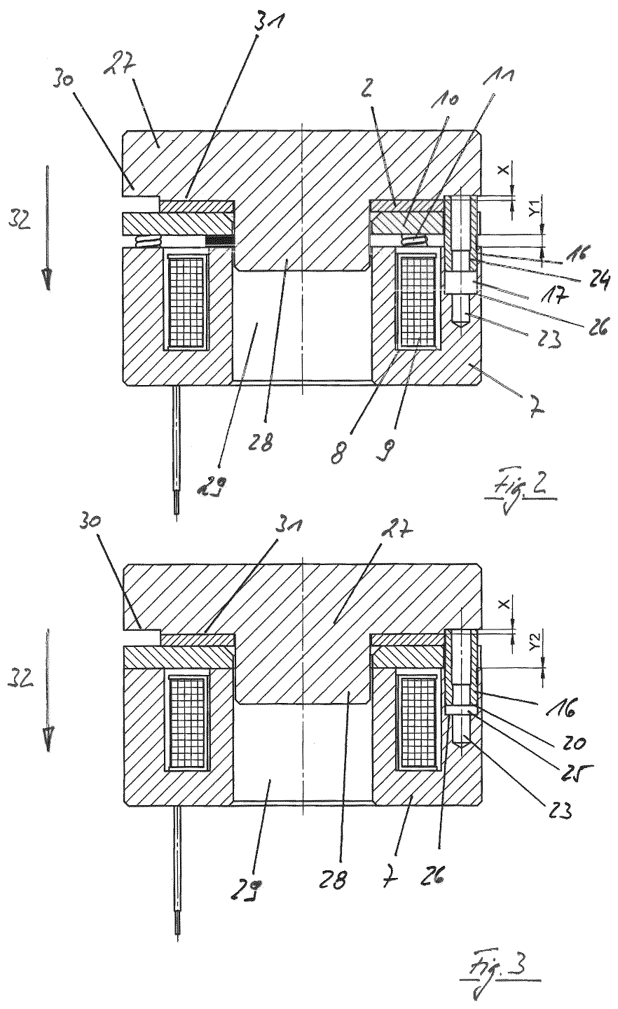

On the method side, a press plunger 27 is used to press a threaded sleeve 16 into the associated blind hole 17, as shown in FIGS. 2 and 3. FIG. 2 shows a first assembly step and FIG. 3 a second assembly step.

According to a first assembly step, the compression spring elements 11 are inserted into the associated bores 12 and the brake disk 2 is placed on the compression spring elements 11 with the armature plate 10 interposed. Furthermore, the threaded sleeves 16 are inserted into the associated blind holes 17 with their respective end section facing the magnet housing 7. The press plunger 27 has two circumferential ring sections, namely a first section 30 and a second section 31. The first section 30 interacts with the threaded sleeves 16, whereas the second section 31 interacts with the brake disk 2.

As can be seen from FIGS. 2 and 3, the second section 31 of the press plunger 27 protrudes in the direction of the arrow 32, i.e. in the axial direction towards the magnet housing 7 relative to the first section 30. The axial distance or offset between the two sections 30 and 31 is the later air gap, i.e. the second section 31 protrudes beyond the first section 30 in the direction of arrow 32 by the gap dimension X.

FIG. 3 shows a second assembly step. According to this assembly step, the press plunger 27 has approached the magnet housing 7 up to “zero”. In this position, the armature plate 10 is pressed against the magnet housing 7, compressing the compression spring elements 11. Further movement of the press plunger 27 in relation to the magnet housing 7 is not possible. For the purpose of an aligned guidance of the press plunger 27, also in order to avoid an uneven application of force to the individual threaded sleeves 16, the press plunger 27 is received during a pressing operation with its section 28 by the opening 29 of the magnet housing 7 and guided thereby.

As can be seen from a comparison of FIGS. 2 and 3, the threaded sleeve 16 has been pressed into the associated blind hole 17 as a result of a movement of the press plunger 27. The gap dimension Y1 previously provided for in FIG. 2 has shrunk to Y2=0. However, the threaded sleeve 16 still protrudes beyond the brake disk 2 by the gap dimension X. The penetration depth of the threaded sleeve 16 into the associated blind hole 17 is therefore a function of the thickness of the armature plate 10 and brake disk 2, whereby any tolerances as a consequence of the resulting penetration depth are advantageously compensated for.

In a final assembly step, which is shown in FIG. 4, the press plunger 27 is removed and the flange 13 is placed on the threaded sleeves 16. The flange 13 can now be screwed to the magnet housing 7 as already described above. In the final assembled state, the compression spring elements press against the armature plate 10, which causes the armature plate 10 to rest against the flange 13 with the brake disk 2 interposed. This creates an air gap between the armature plate 10 and the magnet housing 7, with the gap dimension X, i.e. the gap dimension resulting from the axial offset of the first section 30 and the second section 31 of the press plunger 27.

As can also be seen from a combined view of FIGS. 2 and 4, a blind hole 17 is adjoined by a bore 23 in axial direction 32. In the final assembled state, the associated screw 15 engages in this bore 23, as can be seen from the illustration according to FIG. 4. The screw 15 is therefore not only in operative connection with the threaded sleeve 16, but also with the bore 23. The screw 15 is therefore in direct connection with the magnet housing 7 via the bore 23 and in indirect connection with the magnet housing 7 via the threaded sleeve 16.

For simplified assembly, a thread configuration between the screw 15 and the threaded sleeve 16 does not extend over the entire longitudinal extent of the threaded sleeve 16, but only over a region 24 that extends in the axial direction 32 over a partial section of the threaded sleeve 16.

The screw 15 is designed as a self-furrowing or self-tapping screw, i.e., when the screw 15 is first inserted into the threaded sleeve 16 or the bore 23, a corresponding thread is formed on both the sleeve side and the bore side by self-furrowing or self-tapping. The use of a self-furrowing or self-tapping screw 15 has the advantage that the threaded sleeve 16 cannot unintentionally displace in an axial direction when the screw 15 is screwed into the bore 23. This ensures that the threaded sleeve 16 and thus also the flange 13 are positioned accurately and securely.

FIG. 5 also shows the application force of a spring-applied brake 1 according to the disclosure in a schematic diagram, whereby the force F is removed over the air gap LS.

Two possible embodiments are shown, namely according to the reference signs 101 and 102.

When designing a spring-applied brake 1, three components must be taken into account with regard to the air gap LS, which make up the later air gap LS. These components are the so-called new air gap 301 or 302, the so-called wear reserve 501 or 502 and the tolerance 401 or 402.

“New air gap” refers to the minimum gap dimension that must be present in the non-braking state so that the brake disk 2 can rotate freely when the armature plate 10 is axially displaced. The armature plate 10 must therefore be able to move by at least the dimension of the “new air gap” 301 or 302 in order to release the brake disk 2 from the braked position and transfer it to the non-braked position.

The “wear reserve” is specified by the user and takes into account the fact that the components subject to friction in dynamic braking situations, in particular the brake disk 2, the armature plate 10 and the flange, are subject to wear, which means that the air gap LS inevitably increases during normal operation. Even at maximum wear, the air gap LS must not assume a size or become so large over time that it can no longer be bridged by the applied magnetic field. In this case, it would no longer be possible for the armature plate 10 to be attracted by the electromagnet 6 due to an excessively large air gap LS.

The third component of the air gap LS is the tolerance 401 or 402. The tolerance is the sum of the individual tolerances, which means that the air gap LS is less large if the armature plate 10 and the brake disk 2 are in the upper range of their respective tolerance, and the air gap LS is correspondingly larger if the armature plate 10 and the brake disk 2 are in the lower range of their tolerance window. The electromagnet 6 must also be able to bridge this tolerance range for intended use.

Assuming that the new air gap and the wear reserve are predetermined or cannot technically be undercut, this results in a certain tolerance that is still acceptable if the air gap is designed as intended. As can be inferred from the diagram in FIG. 5, the permissible tolerance is reduced with desirably higher compression spring forces 201 or 202. In other words: In order to obtain a certain torque, greater compression spring forces 201 or 202 are required which must be provided by appropriately designed compression spring elements 11. However, if the tolerances are too high, it is not possible to operate the spring-applied brake 1 as intended because the electromagnet 6 can no longer ensure that the armature plate 10 is attracted as intended due to the excessive air gap LS. It is therefore necessary to optimize the air gap setting in order to be able to provide greater compression spring forces with the aim of achieving a greater torque with an otherwise unchanged design.

This optimized air gap setting is made possible with the design according to the disclosure in that the threaded sleeves 16 are pressed into the associated blind holes 17 in the manner already described above, irrespective of the tolerance, in such a way that a press-in depth is achieved which ensures the desired gap dimension X with regard to the air gap simply by the press plunger 27 moving onto the magnet housing 7 when the armature plate 10 comes to a stop. Due to the radial offset between the sections 30 and 31 of the press plunger 27, a later gap dimension X regarding the air gap, configured as desired, results automatically. As shown in FIG. 5, the tolerance component 401 or 402 of the air gap LS can be advantageously minimized. This optimization can optionally be used for three purposes.

Firstly, a higher torque can be achieved with an otherwise constant installation space, because greater compression spring forces can be applied. Secondly, the electrical power of the electromagnet 6 can be reduced for intended use with unchanged coil dimensions, which reduces energy consumption and also leads to fewer cooling requirements. Thirdly, it is also possible to use a weaker coil 9 with unchanged electrical power, which is geometrically smaller in the axial direction, i.e. shorter, so that a more compact spring-applied brake 1 can be designed in the geometric dimensions. Alternatively, the aforementioned advantages can also be combined with each other.

Whichever of the aforementioned advantages of an optimization according to the disclosure may be desired by the user, it is of decisive importance with regard to the design according to the disclosure that a tolerance-free or in any case tolerance-reduced optimization of the air gap design is possible, and this with equalization of the affected individual part tolerances and at the same time simple assembly.

1. An electromagnetically actuated spring-applied brake comprising:
a brake disk which can be mounted on a shaft in a non-rotatable but axially displaceable manner,
an electromagnet which has a magnet housing and a coil accommodated therein,
an armature plate arranged to be axially displaceable between the brake disk and the magnet housing and
a flange which is arranged non-rotatably on the magnet housing by means of a connecting element,
wherein the brake disk and the armature plate are arranged between the flange and the magnet housing,
wherein the connecting element engages in a counterpart that is designed to correspond to the connecting element and is pressed into a blind hole provided by the magnet housing, the edge of the counterpart facing the magnet housing being arranged at a distance from the bottom of the blind hole while leaving a gap space having a residual volume.

2. The spring-applied brake according to claim 1, wherein the connecting element has a thread.

3. The spring-applied brake according to claim 2, wherein the connecting element is a screw, in particular a thread-furrowing or thread-cutting screw.

4. The spring-applied brake according to claim 1, wherein the counterpart is a threaded sleeve.

5. The spring-applied brake according to claim 4, wherein the connecting element engages releasably in the threaded sleeve.

6. The spring-applied brake according to claim 1, wherein a bore adjoins the blind hole in an axial extension of the blind hole, into which bore the connecting element engages releasably.

7. The spring-applied brake according to claim 1, wherein the bore has a smaller internal diameter than the internal diameter of the blind hole.

8. The spring-applied brake according to claim 4, wherein the threaded sleeve has on the inside a region which interacts with the thread-furrowing or thread-cutting screw and which extends in the axial direction over a partial section of the threaded sleeve.

9. The spring-applied brake according to claim 4, wherein the threaded sleeve has a radially stepped and/or roughened, in particular knurled, region on the outside of its lateral surface, which region extends in the axial direction over a partial section of the threaded sleeve.

10. A method for manufacturing an electromagnetically actuated spring-applied brake according to claim 1, wherein
the magnet housing is fixed in a holding device,
the brake disk is arranged on the magnet housing with the armature plate interposed and
the counterpart is pressed into the blind hole by means of a press plunger,
wherein the press plunger cooperates with a first section with the counterpart and with a second section with the brake disk,
wherein the second section protrudes axially beyond the first section on the magnet housing side and
wherein the press plunger is moved in the direction of the magnet housing until the armature plate strikes against the magnet housing.

11. The method according to claim 10, wherein the armature plate is arranged on the magnet housing with compression spring elements being interposed.

12. The method according to claim 10, wherein the axial offset between the first section and the second section of the press plunger is selected in accordance with a desired air gap between the armature plate and the magnet housing in the final assembled state.

13. The method according to claim 10, wherein the flange is screwed to the magnet housing, with the brake disc, the armature plate and the compression spring elements being interposed, the connecting element used being a screw, in particular a thread-furrowing or thread-cutting screw, which is inserted into the counterpart.
